(19) United States
(12) Patent Application Publication
(10) Pub. No.: US 2005/0044380 A1
(43) Pub. Date: Feb. 24, 2005

(54) Method and system to enable access to multiple restricted applications through user's host application

(75) Inventors: James Edward Bostick, Cedar Park, TX (US); Randolph Michael Forlenza, Austin, TX (US); Pradeep Nambiar, Austin, TX (US)

Correspondence Address: IBM CORPORATION;INTELLECTUAL PROPERTY LAW DEPT, 11400 BURNET ROAD, AUSTIN, TX, 78758, US

(73) Assignee: International Business Machines Corporation, Armonk, NY (US)

(21) Appl. No.: 10/645,178

(22) Filed: Aug. 21, 2003

(51) Int. Cl. H04K 1/00

(52) U.S. Cl. 713/182

(57) ABSTRACT

An example of a solution provided here comprises registering a first restricted application with at least one additional restricted application, and in response to a user performing only a single sign-on for the first restricted application, providing access to the first restricted application for the user, presenting to the user information identifying the at least one additional restricted application, and in response to the user's selection, providing access to the at least one additional restricted application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to computer security, and more particularly to methods and systems for controlling or permitting access to applications.

### BACKGROUND OF THE INVENTION

Users of communications and computer technology typically use multiple password-protected applications, and thus are required to remember (or write down) multiple passwords. Typically, each user is required to register separately as an authorized user of each application, and a user is required to go through a separate log-in sequence to use each application. Various approaches have been proposed for permitting access to multiple applications. Examples include the use of an additional central key repository containing passwords, and the use of a specialized client application for security, with a specialized log-in screen. These solutions may not be convenient or transparent to the user, and may not be easy to administer. Thus there is a need for systems and methods that address these problems of security and convenience, in permitting access to multiple applications.

### SUMMARY OF THE INVENTION

An example of a solution to problems mentioned above comprises registering a first restricted application with at least one additional restricted application, and in response to a user performing only a single sign-on for the first restricted application,
providing access to the first restricted application for the user,
presenting to the user information identifying the additional restricted application(s), and
in response to the user's selection, providing access to the additional restricted application(s).

Access may be provided without the use of additional user passwords and repositories, for accessing the additional restricted application(s).

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a high-level block diagram illustrating an example of a system and method for permitting access to applications, according to the teachings of the present invention.

FIG. 3 is a flow chart illustrating another example of a method for permitting access to applications.

### DETAILED DESCRIPTION

The examples that follow involve the use of one or more computers and may involve the use of one or more communications networks. The present invention is not limited as to the type of computer on which it runs, and not limited as to the type of network used. The example applications may be hosted on the same, or disparate, servers or networks.

The following are definitions of terms used in the description of the present invention and in the claims:

“Application” means any specific use for computer technology, or any software that allows a specific use for computer technology.

“Client” means any application that requests or utilizes a service. Examples of such a service include but are not limited to: information services, transactional services, access to databases, and access to audio or video content.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Log-in,” “logging in,” “sign-on,” or “signing on” refer to any authentication procedure, which may involve a user name, password, or biometrics, to give a few non-limiting examples.

“Output” or “Outputting” means producing, transmitting, or turning out in some manner, including but not limited to printing on paper, or displaying on a screen, writing to a disk, or using an audio device.

“Portal” means any web site providing a variety of services; it may be accessible via the Internet, or an intranet, or some other network.

“Redirect URL” means any uniform resource locator (URL) used to divert a request to another destination.

“Registering” or “registration” refer to any procedure for becoming an identified user.

“Restricted application” means any application that has limits on who may use the application.

“Selection signal” means any signal from a user who is making a selection, utilizing any input device, including a keyboard, speech-recognition interface, or pointing device such as a track ball, a joy stick, a touch-sensitive tablet or screen, or a mouse.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Token” means any string of characters.

“Web application” means any application utilizing a web browser or hypertext transfer protocol (HTTP).

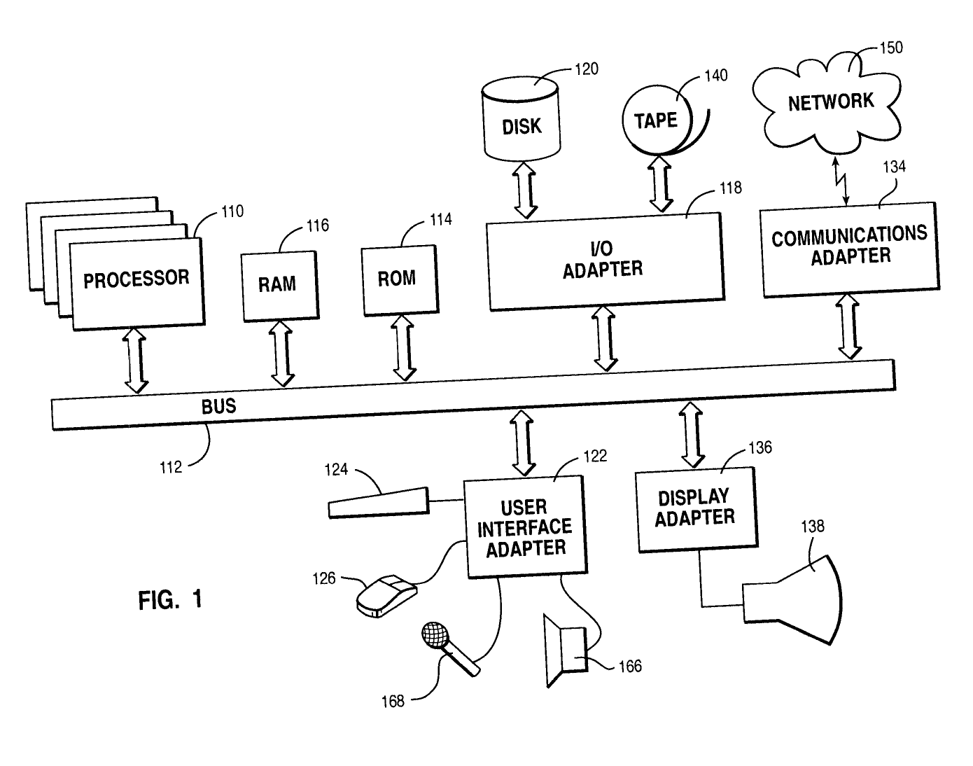

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

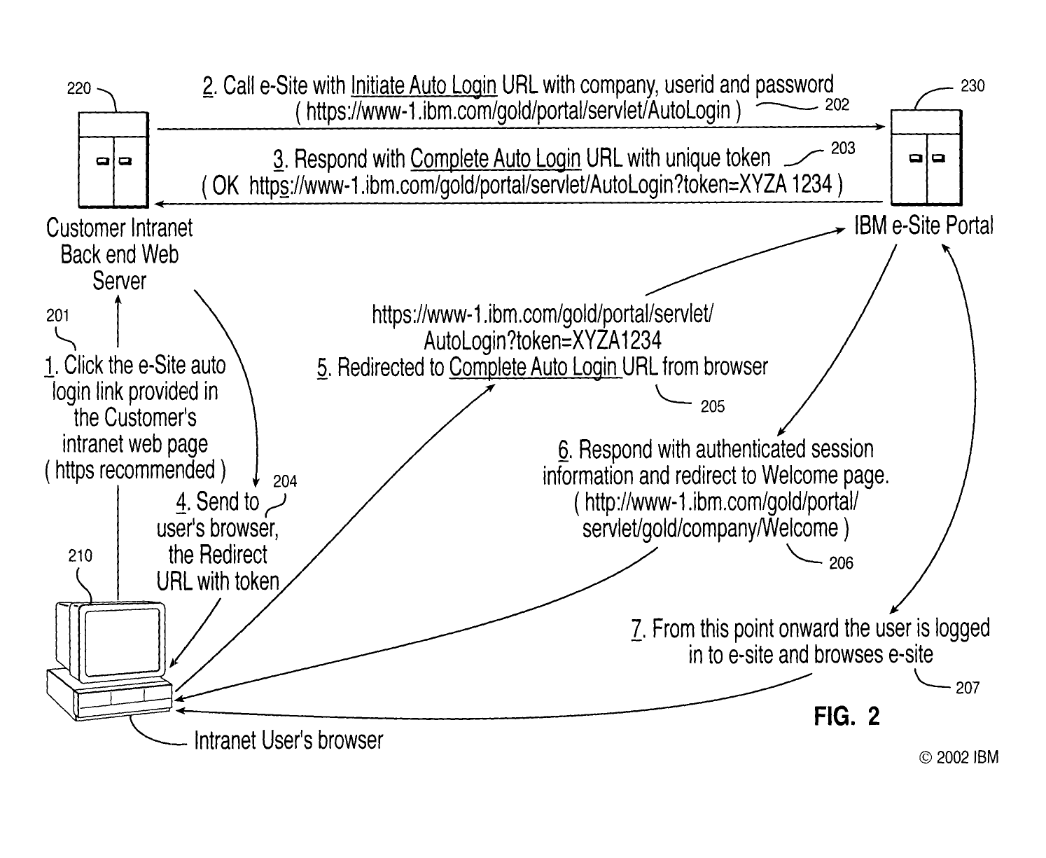

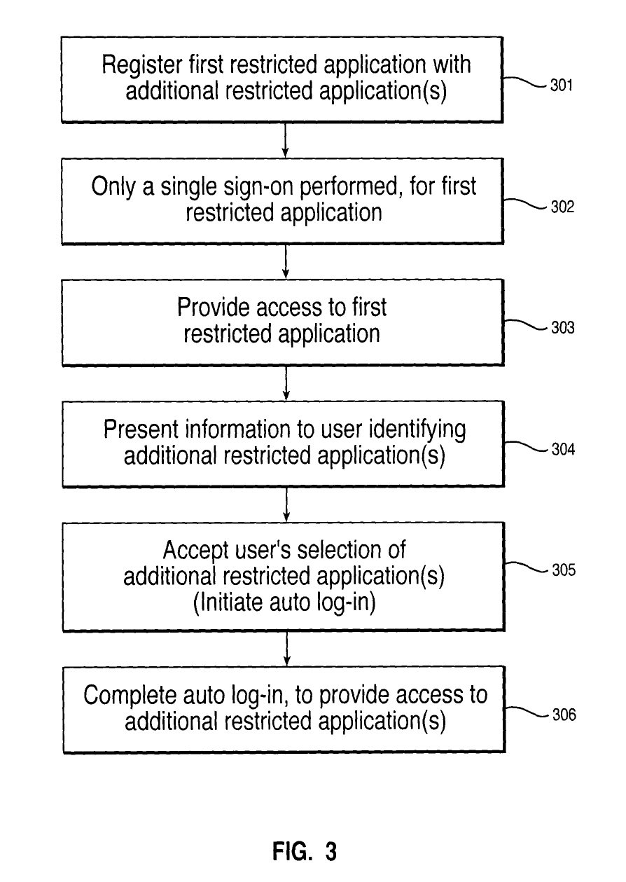

FIG. 2 is a high-level block diagram illustrating an example of a system and method for permitting access to applications, according to the teachings of the present invention. To begin with an overview, this example involves an intranet web server as a first restricted application (at 220) and a portal as a second restricted application (hosted on a server at 230). This example assumes the registering of the first restricted application (at 220) with the second restricted application (at 230). This example assumes that a user (at 210) signs on to the first restricted application (220) only (see the description of FIG. 3 for more detail on these points). In response to the user (at 210) requesting (at 201) access to the second restricted application (at 230), the user is automatically logged in to the second restricted application.

Turning to details of this example in FIG. 2, the intranet web server, symbolized by the “customer intranet back end web server” at 220, serves as the user's host application. This may be any application for which the user is an authorized user (the host application at 220 could be called “company web application” in another example). Here, the intranet web server at 220 is an application that provides services such as information publishing and exchange via an intranet, for authorized employees and customers, for example. Typically, the intranet web server at 220 fetches data from a company database, puts the data into a document in hypertext markup language (web page) and sends it to clients such as the intranet user's browser 210. The user seated at intranet user's browser 210 is an authorized user of the intranet web server at 220. The user at 210 signs on to the user's host application (customer intranet web server at 220) only. Then the user at 210 requests access to the second restricted application, symbolized by the “IBM e-site portal” at 230, hosted on a server that is external to the customer intranet web server. Typically, the portal at 230 is a web site providing a variety of services; it may be accessible via the Internet, or an intranet, or some other network. Typically, the portal at 230 includes a user interface for other applications (e.g. applications for accounting, human resources, inventory, maintenance, or payroll), and a search engine for finding data or documents

Communications between the user's host application at 220 and the second restricted application at 230 (via the Internet or some other network) serve as means for automatically logging in to the second restricted application, for the user at 210. The user's host application at 220 negotiates the authentication to the second restricted application at 230, on the user's behalf, without intervention by the user at 210. The user's intranet web server could also negotiate access (or privilege) levels, depending on rules contained in the user's intranet web server.

Other approaches to the problem of accessing multiple resources utilize an additional centralized database containing multiple passwords for multiple applications (a key repository) for each user. However, in the example in FIG. 2, no additional key repository is required by the first and second restricted applications at 220 and 230 (i.e. a key repository already exists in the first restricted application, and does not need to be further propagated).

Continuing with details of FIG. 2, communications between the first restricted application (user's host application) at 220 and the second restricted application at 230 serve as means for registering a first restricted application with a second restricted application. Consider the communications from the point of view of the server at 220. Processes under control of the first restricted application (at 220) serve as means for:
receiving from the user's client (210) a request (201) for access to the second restricted application (at 230);
determining for the user (at 210), and the second restricted application, what level of access should be granted; and
sending to the second restricted application (at 230) a request (202) to initiate an automatic log-in.

Continuing with details of FIG. 2, consider the communications (via the Internet or some other network) from the point of view of the server at 230. Processes under control of the second restricted application (at 230) serve as means for:
receiving from the first restricted application (at 220), a request (202) to initiate the automatic log-in;
sending (203) to the user's client (210), via the first restricted application (at 220), a response (204), having a complete-automatic-log-in URL, and token;
receiving directly from the user's client (210) a request (205), having the token; and
sending directly to the user's client a response (206), having authenticated session information, and a welcome URL.

(A request or response “having” the token or some other item means that the token or some other item is delivered with the request or response. The request or response includes, but is not limited to, the token or some other item. A request or response may vary from the specific examples shown in FIG. 2.)

Processes under control of the second restricted application (at 230) serve as means responsive to the request (202) to initiate an automatic log-in, for:
creating the token;
storing the token; and
associating the token with the request (202) to initiate an automatic log-in.

To summarize this example so far, the arrows numbered 201-206, and the descriptive words for each arrow, symbolize the requests and responses that serve as means for automatically logging in to the second restricted application at 230, for the user at 210. Two-headed arrow 207 symbolizes providing access to the second restricted application at 230, for the user at 210.

Continuing with details of communications in FIG. 2, consider the request (202) to initiate an automatic login. Data such as a user identification (ID) and password are delivered along with the request at 202. An example request is written along the arrow at 202. The abbreviation “https” signifies the use of hypertext transfer protocol, secure (also abbreviated HTTPS).

HTTPS is also utilized at 201. The words and arrow at 201 symbolize a request sent from the user's client 210. Various kinds of clients (various combinations of hardware and software) could be used. A client application may run on a cell phone, a handheld computer, a desktop computer, or some other kind of computer. In this example, client 210 is a web browser on a desktop computer, using HTTPS in communicating with the back end web server 220, which hosts the customer intranet web page. The embodiment used as an example has the user's host system on an intranet. In practice, it could also be on the Internet. This example involves the user at 210 signing on to the first restricted application (intranet web server at 220) only. This example involves the user at 210 requesting (201) access to the second restricted application (portal at 230), by clicking the e-site portal auto log-in link, provided in the customer intranet web page. An HTTPS request (201) is sent via the intranet to the intranet web server at 220. In response to the request for access, the intranet web server at 220 determines for the user, and for the second restricted application, what level of access should be granted; and sends to the second restricted application at 230 the request 202 to initiate the automatic log-in. A common user ID and password are encrypted and delivered along with the request at 202.

In response to the request 202 to initiate automatic log-in, the second restricted application (the portal) at 230 verifies the user ID and password, and creates a random token, to be used one time only. The portal at 230 stores the token, and associates the token with the request 202 to initiate an automatic log-in. The portal at 230 sends an HTTPS response (203), having a complete-automatic-log-in URL, and the token (encrypted). An example of a response is written along the arrow at 203. The token is represented by the characters “XYZA1234.” The “complete-automatic-log-in” URL refers to any redirect URL that points to the portal at 230, and provides a new address for a request that allows the automatic log-in to be completed. The response having the complete-automatic-log-in URL and the token is sent (204) to the user's client (210), via the intranet web server (at 220).

Using the redirect URL, the user's client 210 immediately sends an HTTPS request (205) for the automatic log-in to be completed. The portal at 230 receives directly from the user's client (210) the request (205), having the token. The portal at 230 verifies the token, deletes the stored token copy (the token could time out or expire if desired), and sends directly to the user's client a response (206). Thus the automatic log-in is completed. Processes under control of the second restricted application (at 230) serve as means for verifying the token received (205) from the user's client (210), and means for establishing a relationship and access level for the user's client (210). The token may represent the appropriate level of access for the user at 210.

An example of a response that completes the automatic log-in is written at 206. The “welcome URL” refers to any redirect URL that allows the user at 210 to reach an entry point, such as a welcome page, for the portal application at 230.

Two-headed arrow 207 symbolizes providing access to the portal application at 230, for the user at 210. From this point (207) onward, the user at 210 is logged in, browsing the IBM e-site portal at 230, and utilizing its services. However, the user at 210 is not required to personally register with the portal at 230. The user at 210 is not required to personally log in to the portal at 230.

FIG. 3 is a flow chart illustrating another example of a method for permitting access to applications. This example begins at block 301, registering a first restricted application (i.e. the user's host application, or any application for which the user is an authorized user, as discussed above in connection with FIG. 2) with at least one additional restricted application. Just one additional restricted application was shown in FIG. 2, to simplify the example, but more than one additional restricted application may be involved in other examples. Registering, at block 301, may in some cases involve performing a single registration for all authorized users of the first restricted application. In other cases, registering may involve performing multiple registrations, for multiple groups of authorized users of the first restricted application, and providing an access level for each of the groups. Appropriate access levels may be assigned to individual users. The first restricted application may negotiate the authorization to the additional restricted application(s).

Consider some possible examples of the first restricted application, and the one or more additional restricted applications. The example method in FIG. 3 is not limited to implementations involving an intranet web server and a portal, as seen in FIG. 2. The example in FIG. 3 assumes that the first restricted application is any useful application; it need not be merely a security mechanism. The first restricted application, or the one or more additional restricted applications, may be a web server, a portal, a web application, or any restricted application utilizing a network. No additional key repository is required by these restricted applications (i.e. a key repository already exists in the first restricted application, and does not need to be further propagated). The example in FIG. 3 is not limited to implementations involving HTTP or HTTPS. Other technologies suitable for networks may be used to implement the invention, such as extensible markup language (XML) or simple object access protocol (SOAP).

Next, at block 302, a user performs only a single sign-on for the first restricted application. At block 303, the first restricted application provides access to that application for the user, in the normal way.

At block 304, the first restricted application presents to the user information identifying the one or more additional restricted applications mentioned in block 301. For example, this may involve the first restricted application sending a document in hypertext markup language to the user's web browser. This may involve any way of outputting a description of options to the user, such as a list or menu.

Next, at block 305, the first restricted application accepts input from the user that signals the user's selection of an additional restricted application. For example, the user clicks a mouse button when a cursor is positioned over a predefined area of the presented information, to produce the selection signal. The first restricted application receives a selection signal from the user. Utilizing communications between the first restricted application and the additional restricted application, the first restricted application negotiates the authentication to the additional restricted application. This may involve collecting stored information regarding a user and an appropriate level of access. In response to the selection signal, the first restricted application sends a request for access to the additional restricted application. (FIG. 2 provides one example of how this may work. Please refer to requests 201 and 202, initiating the automatic log-in, in FIG. 2.)

Next, at block 306, communications among the first restricted application, the additional restricted application, and the user's client application cooperate to provide access to the additional restricted application. A new address and a key may be provided to allow access to the additional restricted application. (FIG. 2 provides one example of how this may work. Please refer to requests and responses 203-206, completing the automatic log-in, in FIG. 2.) For example, the communications may involve sending to the user a token and a redirect URL pointing to the additional restricted application. The token may be encrypted, and in some cases the token may represent the appropriate level of access. For example, tokens that are 32 characters in length, or 128 characters in length, or some other length may be used.

Regarding FIG. 3, the order of the operations described above may be varied. For example, it is within the practice of the invention for block 303, providing access to the first restricted application, to occur simultaneously with block 304, presenting information identifying additional restricted applications. For example, it is within the practice of the invention for block 301, registering the first restricted application with additional restricted application(s), to occur long before, and under the control of a process that is separate from, the operations in blocks 302-306. Those skilled in the art will recognize that blocks in FIG. 3 could be arranged in a somewhat different order, but still describe the invention. Blocks could be added to the above-mentioned diagram to describe details, or optional features; some blocks could be subtracted to show a simplified example.

This final portion of the detailed description presents some details of an example implementation that was provided for a large corporation in the telecommunications industry, in September 2002. This example implementation was provided as part of a portal development project, and was the basis for the simplified example illustrated in FIG. 2. Referring back to FIG. 2, the first restricted application (or user's host application, at 220) was a back-end web server, for a corporate intranet. The second restricted application (at 230) was a portal, hosted on a server that was external to the corporate intranet. The users, corresponding to users seated at the intranet user's browser (210) were authorized users of the corporate intranet, whose sponsor had an authorized relationship with the portal. The implementation allowed users to access the portal (via the Internet), without individually registering with the portal, and without going through multiple sign-ons. The web server for the corporate intranet managed access permissions. No new repository of passwords or access-level data was required. Concerning the passwords and sign-on procedure for authorized users of the corporate intranet, no changes and no extra administrative effort were required. Concerning the password and user ID utilized between servers or applications, one per company was involved (i.e. not a unique password and user ID by individual). The server (230) hosting the portal was not involved with the users' passwords. The implementation utilized Java servlets running on the web server for the corporate intranet, and the server hosting the portal.

In conclusion, we have shown examples of solutions that address problems of security and convenience, in permitting access to multiple applications.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

1. A method for permitting access to applications, said method comprising:
registering a first restricted application with at least one additional restricted application; and
in response to a user performing only a single sign-on for said first restricted application,
providing access to said first restricted application for said user;
presenting to said user information identifying said at least one additional restricted application; and
in response to said user's selection, providing access to said at least one additional restricted application.

2. The method of claim 1, wherein said registering further comprises:
performing a single registration for all authorized users of said first restricted application.

3. The method of claim 1, wherein said registering further comprises:
performing a plurality of registrations,
for a plurality of groups of authorized users of said first restricted application; and
providing an access level for each of said groups.

4. The method of claim 1 wherein:
said first restricted application is an application other than merely a security mechanism.

5. The method of claim 1 wherein:
no additional key repository is required by said restricted applications.

6. The method of claim 1 wherein:
said presenting further comprises said first restricted application sending a document in hypertext markup language.

7. The method of claim 1, wherein said user's selection further comprises:
receiving via said first restricted application a selection signal from said user; and
in response to said selection signal, sending via said first restricted application a request for access to said at least one additional restricted application.

8. The method of claim 7, wherein:
said user clicks a mouse button when a cursor is positioned over a predefined area of said presented information, to produce said selection signal.

9. The method of claim 1, further comprising:
collecting stored information regarding a user and an appropriate level of access; and
sending to said user:
a token and
a redirect URL pointing to said at least one additional restricted application.

10. The method of claim 9, wherein:
said token is encrypted; and
said token represents said appropriate level of access.

11. The method of claim 1, wherein:
one of said restricted applications is an intranet web server.

12. The method of claim 1, wherein:
one of said restricted applications is a portal.

13. The method of claim 1, wherein:
one of said restricted applications is a web application.

14. A method for permitting access to applications, said method comprising:
registering a first restricted application with a second restricted application; and
in response to a user:
signing on to said first restricted application only,
and requesting access to said second restricted application,
automatically logging in to said second restricted application, for said user; wherein:
no new key repository is required by said first and second restricted applications.

15. The method of claim 14, wherein said automatically logging in further comprises:
under control of said second restricted application,
receiving from said first restricted application, a request to initiate said automatically logging in;
sending to said user's client, via said first restricted application a response, having a complete-automatic-log-in URL, and token;
receiving directly from said user's client a request, having said token; and
sending directly to said user's client a response, having authenticated session information, and a welcome URL.

16. The method of claim 15, further comprising:
in response to said request to initiate,
creating said token;
storing a copy of said token; and
associating said token with said request to initiate.

17. The method of claim 15, further comprising:
verifying said token received from said user's client; and
establishing a relationship and access level for said user's client.

18. The method of claim 15 wherein:
said token represents an appropriate level of access.

19. The method of claim 14, further comprising:
under control of said first restricted application,
receiving from said user's client a request for access to said second restricted application;
in response to said request for access, determining for said user, and said second restricted application, what level of access should be granted; and
sending to said second restricted application a request to initiate said automatically logging in.

20. A system for permitting access to applications, said system comprising:
means for registering a first restricted application with a second restricted application; and
means for automatically logging in to said second restricted application, for a user; wherein:
no additional key repository is required by said first and second restricted applications; and
said means for automatically logging in is responsive to said user:
signing on to said first restricted application only,
and requesting access to said second restricted application.

21. The system of claim 20, wherein said means for automatically logging in further comprises:
means for receiving from said first restricted application, a request to initiate said
means for automatically logging in;
means for sending to said user's client, via said first restricted application, a response, having a complete-automatic-log-in URL, and a token;
means for receiving directly from said user's client a request, having said token; and
means for sending directly to said user's client a response, having authenticated session information, and
a “welcome” URL or initial URL.

22. The system of claim 21, further comprising:
means for creating said token;
means for storing a copy of said token; and
means for associating said token with said request to initiate.

23. The system of claim 21, further comprising:
means for verifying said token received from said user's client; and
means for establishing a relationship and access level for said user's client.

24. The system of claim 21, wherein:
said token could represent an appropriate level of access.

25. The system of claim 20, further comprising:
means for receiving from said user's client a request for access to said second restricted application;
means for determining for said user, and said second restricted application, what level of access should be granted; and
means for sending to said second restricted application a request to initiate said means for automatically logging in.

26. A computer-usable medium, having computer-executable instructions for permitting access to applications, said computer-usable medium comprising:
means for registering a first restricted application with a second restricted application; and
means for automatically logging in to said second restricted application, for a user; wherein:
no additional key repository is required by said first and second restricted applications; and
said means for automatically logging in is responsive to said user:
signing on to said first restricted application only,
and requesting access to said second restricted application.

27. The computer-usable medium of claim 26, wherein said means for automatically logging in further comprises:
means for receiving from said first restricted application, a request to initiate said means for automatically logging in;
means for sending to said user's client, via said first restricted application, a response, having a complete-automatic-log-in URL, and token;
means for receiving directly from said user's client a request, having said token; and
means for sending directly to said user's client a response, having authenticated session information, and a welcome URL.

28. The computer-usable medium of claim 27, further comprising:
means for creating said token;
means for storing a copy of said token; and
means for associating said token with said request to initiate.

29. The computer-usable medium of claim 27, further comprising:
means for verifying said token received from said user's client; and
means for establishing a relationship and access level for said user's client.

30. The computer-usable medium of claim 27, wherein:
said token represents an appropriate level of access.

31. The computer-usable medium of claim 26, further comprising:
means for receiving from said user's client a request for access to said second restricted application;
means for determining for said user, and said second restricted application, what level of access should be granted; and
means for sending to said second restricted application a request to initiate said means for automatically logging in.
